(19) United States
(12) Patent Application Publication
(10) Pub. No.: US 2012/0227665 A1
(43) Pub. Date: Sep. 13, 2012

(54) APPARATUS FOR MONITORING AND CONTROLLING SUBSTRATE TEMPERATURE

(75) Inventors: OMER OZGUN, San Jose, CA (US); Didier P. Florin, Sunnyvale, CA (US); Donald J.K. Olgado, Palo Alto, CA (US)

(73) Assignee: APPLIED MATERIALS, INC., Santa Clara, CA (US)

(21) Appl. No.: 13/406,058

(22) Filed: Feb. 27, 2012

Related U.S. Application Data
(60) Provisional application No. 61/451,897, filed on Mar. 11, 2011.

(51) Int. Cl. B05C 11/00; H05B 3/68

(52) U.S. Cl. 118/666; 219/448.17

(57) ABSTRACT

A system and methods for heating substrates during high temperature processing is provided. The system uses multiple temperature inputs of the backside of a substrate carrier and known parameters within the processing chamber to estimate the temperature of substrates being processed on the substrate carrier. Temperature readings of the substrate carrier taken from above the processing volume may be used to correct any drift that may occur with respect to temperature readings taken from below the substrate carrier. Temperature readings of heat exchanging fluid flowing through a showerhead assembly may be used to estimate the temperature of the surface of the showerhead, which may be used in the estimation of the temperature of the substrates being processed. The system then uses the estimated temperature to control the amount of power supplied to a plurality of heat sources configured to heat the substrates from below the substrate carrier.

### CROSS-REFERENCE TO RELATED APPLICATIONS

This application claims benefit of U.S. provisional patent application Ser. No. 61/451,897, filed Mar. 11, 2011, which is herein incorporated by reference.

### BACKGROUND OF THE INVENTION

1. Field of the Invention

Embodiments of the present invention generally relate to methods and apparatus for heating substrates during high temperature processing.

2. Description of the Related Art

Advancements in reliably and consistently forming compound semiconductor layers (e.g., gallium nitride or gallium arsenide layers) that have uniform properties holds much promise for a wide range of applications in the electronics field (e.g., high frequency, high power devices and circuits) and the optoelectronics field (e.g., lasers, light-emitting diodes and solid state lighting). Generally, compound semiconductors are formed by high temperature thermal processes, such as heteroepitaxial growth on a substrate material. The thermal uniformity of the substrate during processing is important, since the epitaxial layer composition, and thus LED emission wavelength and output intensity, are a strong function of the surface temperature of the substrate.

Due to the often long processing times (e.g., 1-24 hours) commonly required to form the compound semiconductor layers used in LED devices, it is often desirable to process substrates in batches of two or more substrates at a time. During batch processing, the substrates are positioned on a supporting structure that is used to support and retain the substrates. However, the ability to control the temperature uniformity from substrate to substrate, and within each substrate, becomes much more difficult in batch configurations. Variations in the substrate surface temperature affect the formation rate of the formed compound semiconductor layer(s) causing them to be non-uniform across the substrate surface. In extreme cases, the substrate can bow enough to crack or break, thus damaging or ruining the compound semiconductor layers grown thereon.

Therefore, there is a need for apparatus and methods that can provide a more uniform or desired temperature profile across all of the substrates disposed in a batch processing chamber.

### SUMMARY OF THE INVENTION

In one embodiment, a substrate processing apparatus comprises a heat source, a showerhead assembly having a plurality of gas passages oriented to deliver one or more process gases to each of a plurality of substrates disposed on a substrate carrier, a susceptor disposed between the heat source and the showerhead assembly and adapted to support the substrate carrier, a plurality of pyrometers positioned on a side of the susceptor opposite the plurality of substrates, and a system controller. The system controller is configured to receive temperature readings from the plurality of pyrometers, estimate the temperature of the plurality of substrates based on the temperature readings, and adjust the power supplied to the heat source based on the estimated temperature of the plurality of substrates.

In another embodiment, a substrate processing apparatus comprises a susceptor adapted to support a substrate carrier on which a plurality of substrates are disposed, a showerhead assembly having a plurality of gas passages oriented to deliver one or more process gases to each of the plurality of substrates, a heat exchanging system configured to circulate a heat exchange fluid through a heat exchanging channel disposed within the showerhead assembly, a temperature sensor positioned to measure the temperature of the heat exchange fluid exiting the showerhead assembly, a heat source positioned on a side of the susceptor opposite the plurality of substrates, a plurality of pyrometers positioned on the side of the susceptor opposite the plurality of substrates, and a system controller. The system controller is configured to receive temperature readings from the plurality of pyrometers and the temperature sensor, estimate the temperature of the plurality of substrates based on the temperature readings, and adjust the power supplied to the heat source based on the estimated temperature of the plurality of substrates.

In yet another embodiment, a method of controlling substrate temperature during substrate processing comprises heating a plurality of substrates positioned on a first side of a substrate carrier disposed in a processing volume of a substrate processing chamber, measuring a temperature of two or more regions of a second side of the substrate carrier which is opposite to the first side, estimating the temperature of the plurality of substrates based on the measured temperature of the two or more regions, and adjusting power to a plurality of heat sources positioned adjacent to the second side of the substrate carrier based on the estimated temperature of the plurality of substrates.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic, cross-sectional view of a processing chamber for fabricating compound nitride semiconductor devices according to one embodiment.

FIG. 2A is a schematic bottom view of the processing chamber in FIG. 1 showing pyrometer locations according to one embodiment.

FIG. 2B is a schematic bottom view of the processing chamber in FIG. 1 showing pyrometer locations according to another embodiment.

FIG. 3 is a schematic depiction of the vertical stack-up of the components of the processing chamber from FIG. 1 that must be taken into account in order to accurately estimate the temperature of the substrates being processed.

FIGS. 4A-4C are simplified block diagrams of a process for controlling the temperature of the substrates within the processing chamber of FIG. 1 according to one embodiment.

### DETAILED DESCRIPTION

Embodiments of the present invention generally relate to a processing chamber and methods for uniformly heating substrates during high temperature processing. In one embodiment, a substrate processing chamber includes heat sources positioned to heat a substrate carrier contained within the chamber. A plurality of temperature probes are positioned to measure the temperature of a backside of the substrate carrier and send signals to a system controller. The system controller estimates the temperature of substrates positioned on the substrate carrier and controls the power to the heat sources based on the estimated temperature. In another embodiment, the processing chamber further includes one or more temperature probes positioned to measure the temperature on the front side of the substrate carrier and send signals to the system controller. The system controller compares the measured temperatures from the front and back side of the substrate carrier in the estimation of the temperature of the substrates and controls the power to the heat sources based on the estimated temperature. In another embodiment, the processing chamber further includes temperature sensors positioned to measure the temperature of heat exchange fluid flowing through a showerhead assembly. The system controller uses the measured temperature of the heat exchange fluid and the estimated temperature of the substrates positioned on the substrate carrier to control the amount of power the heat sources deliver to the substrates positioned on the substrate carrier.

In general, the processing chamber described herein may be a chamber for performing high temperature thermal processes, such as chemical vapor deposition (CVD), hydride vapor phase epitaxy (HVPE) deposition or other thermal processes used to form or process light emitting diode (LED) and laser diode (LD) devices. Moreover, the embodiments of the invention described herein may be applied to and used in any chamber used for epitaxial growth.

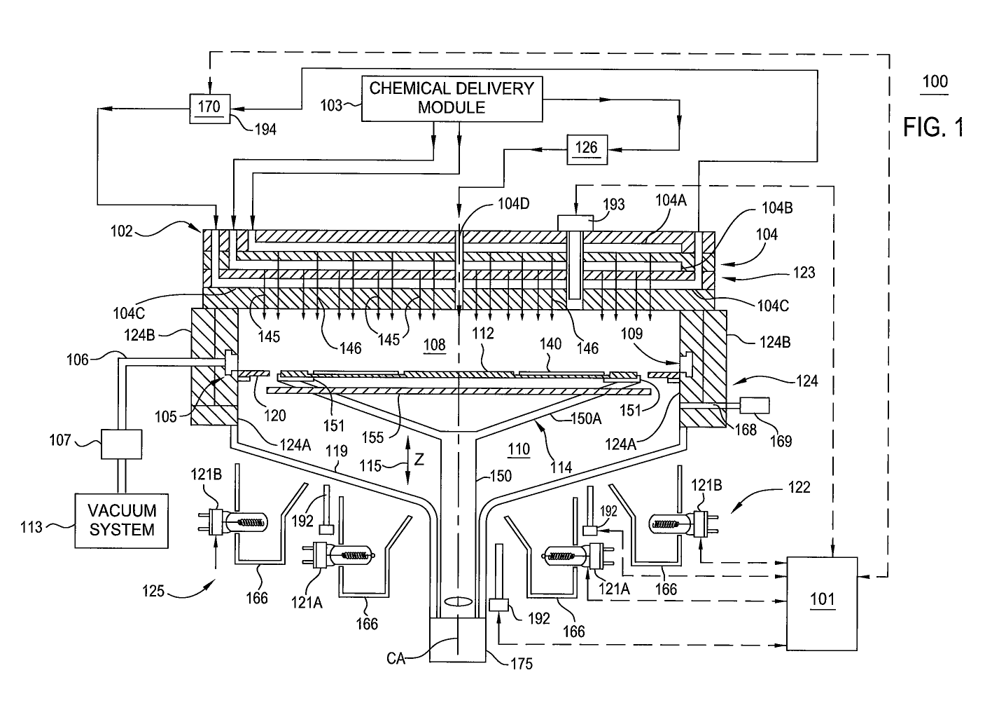

One example of a thermal processing chamber according to an embodiment of the invention is a metal oxide chemical vapor deposition (MOCVD) deposition chamber, which is illustrated in FIG. 1 and is further described below. While the discussion below primarily describes embodiments of the invention being incorporated into an MOCVD chamber, this processing chamber type is not intended to be limiting as to the scope of the invention. For example, the processing chamber may be an HVPE deposition chamber that is available from Applied Materials, Inc. of Santa Clara, Calif.

FIG. 1 is a schematic, cross-sectional view of a processing chamber 100 according to one embodiment. The processing chamber 100 illustrated in FIG. 1 is an MOCVD chamber. The process chamber 100 includes a chamber body 102 that encloses a processing volume 108, a chemical delivery module 103 for delivering process gases to the processing volume 108, a substrate support assembly 114 for supporting a substrate carrier 112 at one end of the processing volume 108, an energy source 122 disposed below the processing volume 108 to heat the substrate carrier 112 and a vacuum system 113 for evacuating the processing volume 108. The chamber body 102 generally includes a lid assembly 123, a lower chamber assembly 125 and a chamber support structure 124. The lid assembly 123 may be disposed at one end of the processing volume 108, and the substrate carrier 112 may be disposed at the other end of the processing volume 108.

The substrate carrier 112 may be disposed on the substrate support assembly 114, and is generally adapted to support and retain one or more substrates 140 during processing in the processing chamber 100. The substrate carrier 112 is generally designed to dampen the spatial variation in the amount of energy delivered from the energy source 122 to the substrates 140 and thus help provide a uniform temperature profile across the each of the substrates 140 disposed on the substrate carrier 112. The substrate carrier 112 is also designed to provide a steady support to each substrate 140 during processing. The substrate carrier 112 is capable of withstanding the high processing temperatures (e.g., >800° C.) used to process substrates in the processing volume 108 of the processing chamber 100. The substrate carrier 112 also has good thermal properties, such as a good thermal conductivity. The substrate carrier 112 also has physical properties similar to the substrates 140, such as having a similar coefficient of thermal expansion, to avoid unnecessary relative motion between the surface of the substrate carrier 112 and the substrates 140 during heating and/or cooling. In one example, the substrate carrier 112 may be made of silicon carbide, or a graphite core that has a silicon carbide (SiC) coating formed by a CVD process over the core. The substrate carrier 112 may have a thickness of between about 0.06 inch (1.5 mm) and about 0.12 inch (3.0 mm). In one configuration, the substrates may be disposed in recesses formed in the substrate carrier 112 that are between about 0.005 inch (0.13 mm) and about 0.02 inch (0.5 mm) deep.

The lid assembly 123 generally includes a showerhead assembly 104 that may have multiple gas delivery manifolds that are each configured to deliver one or more processing gases to the substrates disposed in the processing volume 108. In one configuration, the showerhead assembly 104 includes a first processing gas manifold 104A coupled with the chemical delivery module 103 for delivering a first precursor or first process gas mixture to the processing volume 108, a second processing gas manifold 104B coupled with the chemical delivery module 103 for delivering a second precursor or second process gas mixture to the processing volume 108 and one or more temperature control channels 104C coupled with a heat exchanging system 170 for flowing a heat exchanging fluid through the showerhead assembly 104 to help regulate the temperature of the showerhead assembly 104. In one example, it is desirable to regulate the temperature of the showerhead and surfaces exposed to the processing volume to temperatures less than about 200° C. at substrate processing temperatures between about 800° C. and about 1300° C. During processing the first precursor or first process gas mixture may be delivered to the processing volume 108 via gas conduits 146 coupled with the first processing gas manifold 104A in the showerhead assembly 104. The gas conduits 146 may pass through, but be isolated from, the second processing gas manifold 104B and the one or more temperature control channels 104C. The second precursor or second process gas mixture may be delivered to the processing volume 108 via gas conduits 145 coupled with the second processing gas manifold 104B. The gas conduits 145 may pass through, but be isolated from, the one or more temperature control channels 104C. In some configurations, a remote plasma source 126 is adapted to deliver gas ions or gas radicals to the processing volume 108 via a conduit 104D disposed through the showerhead assembly 104. It should be noted that the process gas mixtures or precursors may include one or more precursor gases or process gases as well as carrier gases and dopant gases which may be mixed with the precursor gases.

The lower chamber assembly 125 generally includes a lower dome 119, the energy source 122 disposed adjacent to the lower dome 119, and a substrate support assembly 114. The lower dome 119 is disposed at one end of a lower volume 110, and the substrate carrier 112 is disposed at the other end of the lower volume 110. The substrate carrier 112 is shown in the process position, but may be moved to a lower position where, for example, the substrates 140 and/or substrate carrier 112 may be loaded or unloaded. An exhaust ring assembly 120 may be disposed around the periphery of the substrate carrier 112 to help prevent deposition from occurring in the lower volume 110 and also help direct exhaust gases from the processing volume 108 to exhaust ports 109. The lower dome 119 may be made of transparent material, such as high-purity quartz, to allow energy (e.g., light) delivered from the energy source 122 to pass through for radiant heating of the substrates 140. The radiant heating provided from the energy source 122 may be provided by a plurality of inner lamps 121A and outer lamps 121B disposed below the lower dome 119. Reflectors 166 may be used to help control the processing chamber exposure to the radiant energy provided by inner and outer lamps 121A, 121B. Additional rings of lamps may also be used for finer temperature control of the substrates 140. In other embodiments, the energy source 122 may include embedded IR heating elements or induction heating elements.

A purge gas (e.g., a nitrogen containing gas) may be delivered into the processing chamber 100 from the showerhead assembly 104 and/or from inlet ports 168, coupled to a gas source 169, that are disposed below the substrate carrier 112 and near the bottom of the chamber body 102. The purge gas enters the lower volume 110 of the chamber 100 and flows upwards past the substrate carrier 112 and exhaust ring assembly 120 and into the exhaust ports 109 which are disposed around an annular exhaust channel 105. An exhaust conduit 106 connects the annular exhaust channel 105 to the vacuum system 113, which includes a vacuum pump 107. The chamber pressure may be controlled using a valve system which controls the rate at which the exhaust gases are drawn from the annular exhaust channel.

In some configurations of the processing chamber 100, a baffle plate 155 is disposed between the substrates 140 and the energy source 122 to prevent the interaction of the purge gas delivered into the lower volume 110 from inlet ports 168 and the substrate carrier 112, and to also help dampen the thermal variation created by the non-uniform distribution of lamps 121A, 121B below the substrate carrier 112. The baffle plate 155 may be made of transparent material, such as high-purity quartz, to allow energy (e.g., light) delivered from the energy source 122 to pass through for radiant heating of the substrates 140.

The chamber support structure 124 generally includes one or more walls, such as an inner wall 124A and an outer wall 124B, that are configured to support the lid assembly 123 and lower chamber assembly 125. One or more of the walls generally includes a metal sheet or plate that may act as the structural support and vacuum sealing surface that is attached to an external support structure, for example, a chamber position in a Centura™ cluster tool (not shown) available from Applied Materials, Inc. of Santa Clara, Calif.

The chamber support structure 124 is used in combination with the lid assembly 123 and lower chamber assembly 125 to enclose the processing volume 108 and lower volume 110. In an effort to assure that the high processing temperatures used to process the substrates do not affect the external support structure and other adjacent components, the temperature of the walls of the chamber body 102 and surrounding structures is controlled by circulating a heat-exchange liquid through channels (not shown) formed in one or more of the walls of the chamber body 102. The heat-exchange liquid can be used to heat or cool the chamber walls depending on the desired effect. For example, a cool liquid may be used to remove heat from the chamber body 102 during processing to limit formation of deposition products on the walls, and/or for personnel safety reasons. Typically, the one or more walls are maintained at temperatures less than about 200° C., while the substrate are being processed at temperatures between about 800° C. and about 1300° C. In some configurations, the inner wall 124A is formed from a thermally insulative material, such as a ceramic material, and the outer wall 124B is formed from a metal, such as stainless steel or aluminum.

The substrate support assembly 114 is generally configured to support and retain the substrate carrier 112 during processing, and may include a substrate support 150 that has a plurality of angled supports 150A on which substrate carrier supporting features 151 are disposed. The substrate support assembly 114 generally includes an actuator assembly 175 that is configured to provide z-lift capability and rotate the substrate support 150, substrate carrier 112 and substrates 140 about a central axis “CA” during processing. The z-lift capability is provided to allow movement of the substrate carrier 112 in a vertical direction, as shown by arrow 115. For instance, the z-lift capability may be used to move the substrate support 150 upward and closer to the showerhead assembly 104 or downward and further away from the showerhead assembly 104. The z-lift hardware components (e.g., stepper motor, lead-screw hardware) and a system controller 101 (e.g., conventional industrial computer/controller) are used to adjust the substrate carrier 112 and/or substrate support 150 position relative to the showerhead assembly 104 during one or more steps, or sub-steps, during a deposition process performed in the process chamber 100. In one embodiment, each individual substrate 140 may be rotated as well using hardware (not shown), such as one or more motors and gear systems.

The system controller 101 generally includes a computer processor, support circuits and a computer-readable memory coupled to the processor. The processor executes system control software, such as a computer program stored in memory. In some configurations, the system controller 101 may use a substrate positioning subroutine that includes software that is used to control the chamber components that are used to load the substrates 140 and substrate carrier 112 onto the substrate support 150 and, optionally, to control the spacing between the substrates 140 and the showerhead assembly 104 during processing. When a substrate 140 is to be loaded into the process chamber 100, the substrate support 150 is lowered to receive the substrate carrier 112 and substrates 140. The substrate support 150 is then raised to the desired height in the process chamber 100. During processing, the substrate positioning subroutine can be used to control movement of the z-lift components, and thus the position of the substrate support 150 relative to the showerhead assembly 104 in response to varying process parameters and/or during different substrate or process chamber cleaning steps. It should be noted that the substrate position relative to the cooled showerhead assembly 104 can affect the actual temperature of the substrates 140 during processing. Thus, processes performed in the process chamber 100 need a robust closed-loop thermal control system to achieve a desired device yield.

In certain embodiments, the substrate support assembly 114 includes a heating element, for example, a resistive heating element (not shown) for controlling the temperature of the substrate support assembly 114 and consequently controlling the temperature of the substrate carrier 112 positioned on the substrate support assembly and the substrates 140 positioned on the substrate carrier 112. In general, the cross-section of the angled supports 150A are sized to minimize the amount of heat that is conducted away from the processing volume 108 to the lower chamber assembly 125 components, such as the actuator assembly 175. In one example, the angled supports 150A are formed from an insulating material, such as quartz, to reduce the amount of heat conduction to the lower chamber assembly 125 components.

During processing, electromagnetic energy may be emitted from the energy delivery components (e.g., lamps 121A, 121B, embedded heating elements, induction heating elements) found in the energy source 122 and delivered to a backside of the substrate carrier 112 positioned on the substrate support assembly 114 to achieve a desired temperature during processing the substrates 140 positioned on the substrate carrier 112. The temperature of the substrates 140 are maintained at a desired processing temperature using a closed-loop control system. The closed-loop control system, which is found in or is used in conjunction with the system controller 101, uses a plurality of temperature inputs to maintain a desired substrate processing temperature and/or chamber hardware component temperature during processing.

The temperature input signals delivered to the system controller 101 may be generated by a plurality of pyrometers 192 positioned below the lower dome 119. Although only three pyrometers 192 are shown in FIG. 1, this is not meant to limit the scope of the invention as any number of pyrometers necessary to control and uniformly provide a desired temperature across the substrates 140, which are typically disposed on a substrate carrier 112, in accordance with the control scheme described herein may be used. The temperature inputs from each of the plurality of pyrometers 192 are used to proportionally control two or more energy delivery components, such as the plurality of inner lamps 121A and outer lamps 121B shown in FIG. 1, to provide a desired temperature profile across the backside of the substrate carrier 112, and ultimately provide a uniform temperature profile across each of the substrates 140 positioned thereon. The pyrometers 192 may be positioned to monitor the temperature of a surface of the substrate carrier 112 because it may be difficult to detect the temperature of the substrates 140 themselves due to their transparent nature (e.g., quartz substrates, transparent films on substrates 140). Since the pyrometers 192 are positioned to monitor the temperature of a surface of the substrate carrier 112, the readings from the pyrometers 192 do not reflect the actual temperature of the substrates 140 being processed. Therefore, the temperature of the substrates 140 must be estimated by taking physical parameters of the processing chamber 100 into account.

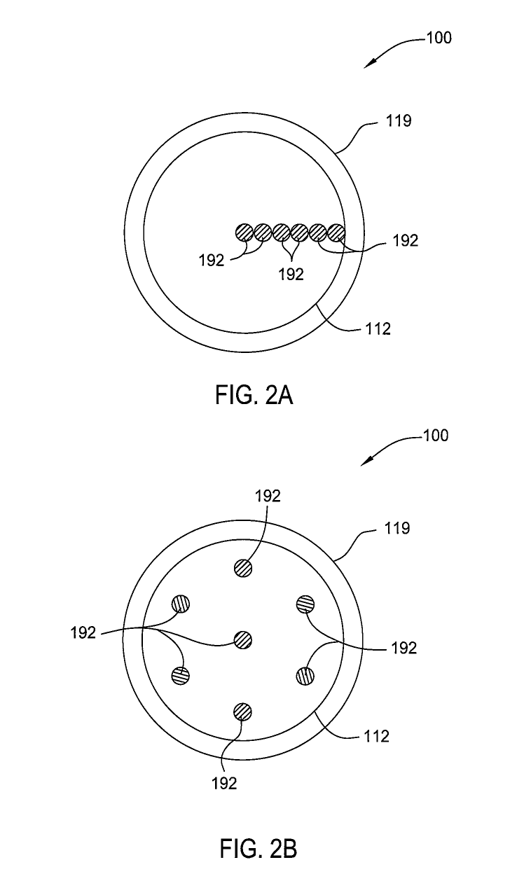

FIG. 2A is a bottom view of the processing chamber in FIG. 1 showing pyrometer 192 locations according to one embodiment of the invention. In one embodiment, the process chamber 100 includes a plurality of pyrometers 192 arranged in a radial line from the center of the processing chamber 100 to the perimeter of the process chamber 100. In such an embodiment, the pyrometers 192 are arranged so that they can detect the temperature distribution from the center to the perimeter of the substrate carrier 112 (FIG. 1). Additionally, the pyrometers 192 may be arranged such that certain pyrometers 192 are arranged to measure the temperature of the substrate carrier 112 directly beneath the substrates 140 (e.g., aimed at pockets in the substrate carrier 112 which hold individual substrates 140). Other pyrometers 192 may be arranged to detect the temperature of the backside of the substrate carrier 112 at the edge (i.e, perimeter of the substrate carrier). Thus, the temperature difference between the substrate carrier 112 directly beneath substrates 140 and at the edge of the substrate carrier 112 can be detected and used in the temperature control system.

FIG. 2B is a bottom view of the processing chamber in FIG. 1 according to another embodiment of the invention. In one embodiment, the process chamber 100 includes one pyrometer 192 positioned at the center of the process chamber 100 and a plurality of pyrometers 192 arranged in a concentric pattern about the center of the process chamber 100.

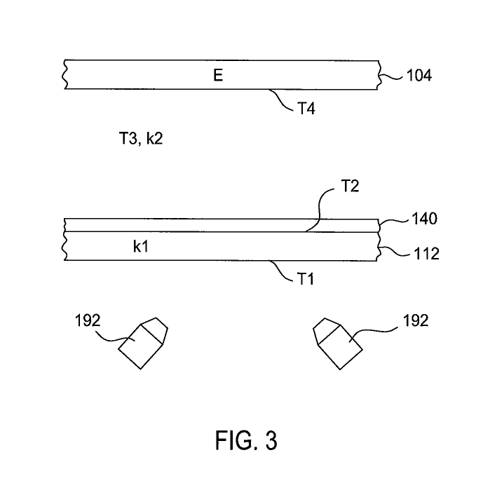

FIG. 3 is a schematic depiction of the vertical stack-up of the components of the processing chamber 100 that must be taken into account in order to accurately estimate the temperature of the substrates 140. Referring to FIGS. 1 and 2, it should be noted that the pyrometers 192 are positioned to directly detect the temperature of the backside of substrate carrier 112. This is possible because the substrate support 150, which supports the substrate carrier 112, is ring-shaped rather than being a solid, disc-shaped susceptor. The ring-shaped substrate support 150 supports the substrate carrier 112 about an outer peripheral region of the substrate carrier 112, which provides a large open region underneath the substrate carrier 112 so that the pyrometers 192 have direct access to the backside of the substrate carrier 112 as shown in FIG. 2. One reason for detecting temperature from the backside of the substrate carrier 112 is because detection of the substrates themselves may be difficult due to their transparent properties (e.g., quartz material) or transparent films (e.g., gallium films) disposed on the substrates 140. Additionally, since the lower dome 119 and the optional baffle plate 155 are constructed of a transparent material, the optics of the pyrometers 192 are able to measure the temperature of the backside of the substrate carrier 112 without interruption. Additionally, since the temperature of the substrate carrier 112 is measured from the backside, or the side opposite the processing volume 108, the measured temperature is not subject to process drift due to changes in emissivity that may be caused by deposition on the surface being measured. Thus, the backside temperature (T1) of the substrate carrier 112 can be reliably and accurately measured using the plurality of pyrometers 192.

Still referring to FIG. 3, the scheme for estimating the actual temperature of the substrates 140 must next take into account the thermal conductivity of the substrate carrier 112 (k1), which allows an estimation of the front-side temperature (T2) of the substrate carrier 112 (i.e., the estimated temperature of the surface of the substrate carrier 112 beneath the substrate 140. Additionally, the effects of the temperature of the processing volume 108 (T3), including the thermal conductivity of the gases in the processing volume 108 (k2), on the substrates 140 must be taken into account to accurately estimate the temperature of the substrates 140.

Another factor affecting the temperature of the processing volume 108, and thus the temperature of the substrates 140, is the temperature (T4) and emissivity (E) of the showerhead assembly 104. The temperature of the showerhead assembly 104 may be controlled by flowing heat exchange fluid through the temperature control channel 104C. Additionally, the emissivity of the surface of the showerhead assembly 104 adjacent to the processing volume 108, when in new condition, is typically much lower than the emissivity of the surface after a number of processing steps have been performed in the process chamber 100. The emissivity of typical showerhead materials may change due to adhesion of precursor materials, corrosion, and/or oxidation of the exposed surface of the showerhead assembly 104. At the high processing temperatures used to form LED or LD devices, the change in emissivity of the surface of the showerhead assembly 104 causes significant process drift as the showerhead assembly 104 absorbs more heat and affects the temperature of the processing volume 108, which in turn, introduces uncertainty into the substrate temperature estimation.

To address this issue, the showerhead assembly 104 is provided with a surface treatment or coating to minimize adhesion of precursor materials and provide the surface of the showerhead assembly 104 that has a consistent emissivity over a number of process cycles. In one example, the surface of the showerhead assembly 104 is roughened to increase the initial emissivity of the surface and reduce the emissivity change caused during processing. In another example, the surface of the showerhead assembly 104 has a coating of ceramic material, such as alumina or aluminum oxide, zirconium oxide, yttrium, yttrium oxide, chromium oxide, or silicon carbide. Such coatings maximize the emissivity and stabilize the emissivity of the surface of the showerhead assembly 104 in order to provide a consistent emissivity and minimize or eliminate the effect of process drift.

Referring back to FIG. 1, additional temperature inputs to the system controller 101 for use in controlling the temperature of the substrates 140 may be received from one or more temperature probes 193 (e.g., pyrometers) disposed within the showerhead assembly 104. The temperature probes 193 may be disposed in ports extending through the showerhead assembly 104 that are configured to allow an inert gas to be delivered around the temperature probes 193 to prevent deposition and/or condensation of various gas or volatile components from occurring on the surface of the temperature probes 193.

Still further temperature inputs may be received by the system controller from a temperature sensor 194 positioned to sense the temperature of the cooling fluid exiting the showerhead assembly 104. Since radiative heat transfer, which is the dominant heat transfer mechanism at LED or LD processing temperatures, is proportional to the temperature of the radiating and receiving bodies each to the fourth power, variations in the temperature of the surface of the showerhead assembly 104 during a single processing run, or from one processing run to another, can have a dramatic affect on the actual processing temperature of the substrates 140 during parts of the single processing run, or from one processing run to another, if the power delivered by the energy delivery components is not suitably adjusted to compensate for these variations. Therefore, since the temperature and/or variation in temperature of the surface of the showerhead assembly 104 can be inferred from the signal received from the temperature sensor 194, the actual temperature of the substrates 140 during a single processing run, or from one processing run to another, can be better controlled to improve LED/LD device yield and reduce LED/LD device performance variability. Alternately, in one configuration, the temperature of the surface of the showerhead assembly 104 adjacent to the processing volume 108 is directly measured (e.g., thermocouple, RTD) and the signal is delivered to the system controller 101 for use in the control of the substrate temperature.

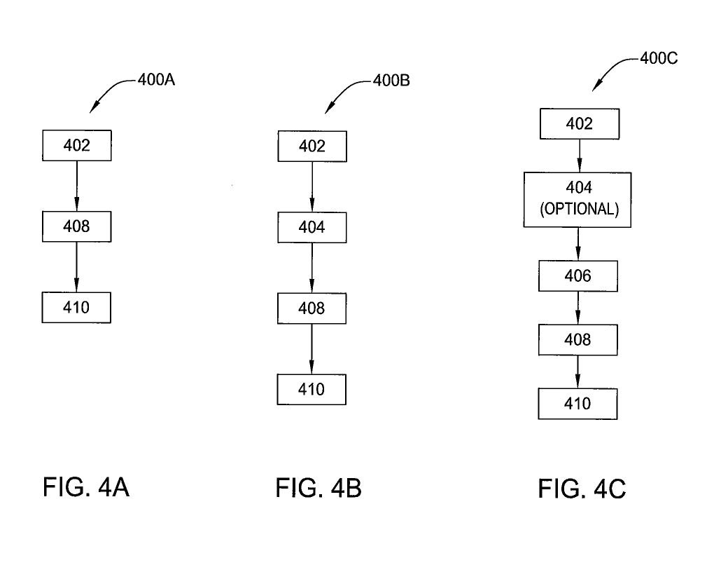

FIG. 4A is a simplified block diagram of a process 400A for controlling the temperature of the substrates 140 within the processing chamber 100 according to one embodiment. In block 402, the system controller 101 receives inputs, or temperature signals from each of the plurality of pyrometers 192. Based on the received readings from each pyrometer 192, and the known contributions of the vertical chamber component stack-up described above with respect to FIG. 3 (i.e., k1, k2, E, etc.), the temperature of the substrates 140 are estimated in block 408 in the system controller 101. Based on the temperature estimation in block 408, a comparison between the estimated temperature of the substrates 140 and a desired temperature of the substrates 140 is made in the system controller 101. Based on the comparison, power output signals are sent from the system controller 101 to each of the energy delivery components, such as the inner lamps 121A and the outer lamps 121B, as well as any additional rings of lamps provided in the processing chamber 100, in block 410. Thus, accurate temperature control of the substrates 140 is provided using a system that receives multiple, different temperature inputs (i.e., plurality of pyrometer 192 inputs) and sends multiple outputs (i.e., output signals to control the power of lamps 121A, 121B) based on the information received by the multiple, different temperature inputs. It is believed that this novel temperature control configuration has advantages over other closed loop temperature control configurations that have multiple powered zones that utilize a temperature sensing device to separately control each zone, due to the unavoidable interaction of adjacent zones caused by the delivery of thermal energy (e.g., lamp power) from each zone to other adjacent zones. The novel temperature control configuration compensates for the unwanted interaction of adjacent zones by the collection and analysis of the multiple input signals by the system controller before sending out the desired output signals to the temperature controlling devices, thus preventing the common “fight” between adjacent zones to provide thermal control to their respective region of the chamber found in conventional temperature control schemes.

FIG. 4B is a simplified block diagram for a process 400B including additional temperature inputs for controlling the temperature of the substrates 140 within the processing chamber 100 according to one embodiment. The processes in block 402 are the same in the process 400B as that of 400A described above. In block 404, additional temperature inputs are received by the system controller 101 based on temperature readings from the one or more temperature probes 193. The temperature probes 193 are positioned above the substrates 140 positioned on the substrate carrier 112 and may be periodically used to directly detect the temperature of the side of the substrate carrier 112 on which the plurality of substrates are disposed. The temperature inputs received by the system controller 101 in block 404 may be used in block 408 to identify and correct drift from the temperature inputs from the pyrometers 192. However, control based on the continuous detection of the substrate temperature from the temperature probes 193 in some cases is not provided due to the effects of process drift on the temperature probes 193 (i.e., effect of precursor gases within the processing volume 108 as well as adhesion of precursor materials on the temperature probes 193 or windows (not shown) covering the temperature probes 193). The processes in block 410 in the process 400B are the same as that of process 400A described above with respect to FIG. 4A.

FIG. 4C is a simplified block diagram for a process 400C including additional temperature inputs for controlling the temperature of the substrates 140 within the processing chamber 100 according to one embodiment. The processes in block 402 are the same in the process 400C as that of 400A described above. Additionally, the process 400C may optionally include the processes in block 404 described above with respect to FIG. 4B. In block 406, additional temperature inputs are received by the system controller 101 from the one or more temperature sensors 194 positioned to measure temperature of the heat exchange fluid circulating through the showerhead assembly 104. In block 408, the temperature of the heat exchange fluid may be used to determine the temperature of the showerhead assembly 104, and hence the showerhead assembly surface temperature (T4). In one configuration, at block 406, the system controller 101 is configured to receive inputs from the one or more temperature sensors 194 positioned to measure the actual surface temperature of the showerhead assembly 104. As described above, this temperature may then be used along with the other temperature inputs to estimate the temperature of the substrates 140. In one embodiment, multiple temperature readings are taken over time and used along with the other temperature inputs to re-estimate the temperature of the substrates 140 over time during processing. The processes in block 410 in the process 400C are the same as that of process 400A described above with respect to FIG. 4A.

Thus, a system for controlling the temperature of substrates in a processing chamber during deposition processing is provided. The system uses multiple temperature inputs of the backside of the substrate carrier and known parameters within the processing chamber to estimate the temperature of the substrates being processed. By detecting the temperature from below the substrate carrier, the pyrometers used to detect the temperature may be isolated from precursors and resulting deposited materials used during the deposition processes. In one embodiment, temperature readings of the substrate carrier taken from above the processing volume are used to correct any drift that may occur with respect to the pyrometer readings taken from below the substrate carrier. In one embodiment, temperature readings of heat exchanging fluid flowing through the showerhead assembly are used to estimate the temperature of the surface of the showerhead, which is further used in the estimation of the temperature of the substrates being processed. Accurate estimation of the temperature of the showerhead surface allows a more accurate estimation of the temperature of the substrates being processed, which increase LED/LD device yield and reduce LED/LD device performance variability. The system then uses the estimated temperature to control the amount of power supplied to heat sources configured to heat the substrates from below the substrate carrier.

While the foregoing is directed to embodiments of the present invention, other and further embodiments of the invention may be devised without departing from the basic scope thereof, and the scope thereof is determined by the claims that follow.

1. A substrate processing apparatus, comprising:
a heat source;
a showerhead assembly having a plurality of gas passages oriented to deliver one or more process gases to each of a plurality of substrates disposed on a substrate carrier;
a susceptor disposed between the heat source and the showerhead assembly and adapted to support the substrate carrier;
a plurality of pyrometers positioned on a side of the susceptor opposite the plurality of substrates; and
a system controller configured to receive temperature readings from the plurality of pyrometers, estimate the temperature of the plurality of substrates based on the temperature readings, and adjust the power supplied to the heat source based on the estimated temperature of the plurality of substrates.

2. The apparatus of claim 1, further comprising one or more temperature probes coupled to the showerhead assembly.

3. The apparatus of claim 2, wherein the system controller is further configured to receive signals from the one or more temperature probes and adjust the temperature readings from the plurality of pyrometers based on the signals from the one or more temperature probes.

4. The apparatus of claim 1, wherein the heat source comprises a plurality of lamps.

5. The apparatus of claim 4, wherein the plurality of lamps comprise two or more concentric arrays of lamps.

6. The apparatus of claim 1, further comprising a baffle plate positioned between the heat source and the plurality of pyrometers.

7. A substrate processing apparatus, comprising:
a susceptor adapted to support a substrate carrier on which a plurality of substrates are disposed;
a showerhead assembly having a plurality of gas passages oriented to deliver one or more process gases to each of the plurality of substrates;
a heat exchanging system configured to circulate a heat exchange fluid through a heat exchanging channel disposed within the showerhead assembly;
a temperature sensor positioned to measure the temperature of the heat exchange fluid exiting the showerhead assembly;
a heat source positioned on a side of the susceptor opposite the plurality of substrates;
a plurality of pyrometers positioned on the side of the susceptor opposite the plurality of substrates; and
a system controller configured to receive temperature readings from the plurality of pyrometers and the temperature sensor, estimate the temperature of the plurality of substrates based on the temperature readings, and adjust the power supplied to the heat source based on the estimated temperature of the plurality of substrates.

8. The apparatus of claim 7, wherein the system controller is configured to estimate the temperature of the showerhead assembly using the temperature readings from the temperature sensor.

9. The apparatus of claim 7, further comprising one or more temperature probes coupled to the showerhead assembly.

10. The apparatus of claim 9, wherein the system controller is further configured to receive signals from the one or more temperature probes and adjust the temperature readings from the plurality of pyrometers based on the signals from the one or more temperature probes.

11. The apparatus of claim 7, wherein the heat source comprises a plurality of lamps.

12. The apparatus of claim 11, wherein the plurality of lamps comprise two or more concentric arrays of lamps.

13. The apparatus of claim 7, further comprising a baffle plate positioned between the heat source and the plurality of pyrometers.

14. A method of controlling substrate temperature during substrate processing, comprising:
heating a plurality of substrates positioned on a first side of a substrate carrier disposed in a processing volume of a substrate processing chamber;
measuring a temperature of two or more regions of a second side of the substrate carrier which is opposite to the first side;
estimating the temperature of the plurality of substrates based on the measured temperature of the two or more regions; and
adjusting power to a plurality of heat sources positioned adjacent to the second side of the substrate carrier based on the estimated temperature of the plurality of substrates.

15. The method of claim 14, further comprising measuring a temperature of the first side of the substrate carrier.

16. The method of claim 15, further comprising correcting the measured temperature of the second side of the substrate carrier using the measured temperature of the first side of the substrate carrier.

17. The method of claim 14, further comprising measuring a temperature of a heat exchange fluid circulated through a showerhead assembly positioned over the first side of the substrate carrier.

18. The method of claim 17, further comprising estimating a temperature of the showerhead assembly using the measured temperature of the heat exchange fluid.

19. The method of claim 18, further comprising using the estimated temperature of the showerhead assembly during estimating the temperature of the plurality of substrates.

20. The method of claim 14, further comprising:
measuring a first temperature of a heat exchange fluid circulated through a showerhead assembly positioned over the first side of the substrate carrier at a first time, wherein estimating the temperature of the plurality of substrates further comprises adjusting the estimated temperature based on the measured first temperature of the heat exchange fluid;
measuring a second temperature of the heat exchange fluid circulated through the showerhead assembly at a second time;
re-estimating the temperature of the plurality of substrates using the measured temperature of the two or more regions and the measured second temperature of the heat exchange fluid; and
re-adjusting the power to the plurality of heat sources based on the re-estimated temperature of the plurality of substrates.
